(19) United States
(12) Patent Application Publication
(10) Pub. No.: US 2011/0256950 A1
(43) Pub. Date: Oct. 20, 2011

(54) Custom Cork Ring Grips

(76) Inventor: James M. Claire, White Cloud, MI (US)

(21) Appl. No.: 12/873,722

(22) Filed: Sep. 1, 2010

Related U.S. Application Data
(60) Provisional application No. 61/342,632, filed on Apr. 19, 2010.

(51) Int. Cl. A63B 53/14; B32B 38/04

(52) U.S. Cl. 473/303; 473/300; 156/266; 156/252

(57) ABSTRACT

A method of making a grip for a handle includes forming a substantially cylindrical body portion from a material at least partially comprised of cork and forming an elongate cavity through the substantially cylindrical body portion. The method also includes separating the substantially cylindrical body portion into a plurality of ring segments each having an inner surface area, first side surface area, second side surface area, and an outer surface area, applying an adhesive to the inner surface area, first side surface area, and second side surface area and applying the ring segments to a handle, such that each of the plurality of ring segments securely adheres to the handle and to an adjacent ring segment. The method further includes pressing each of the plurality of ring segments onto the handle to form the grip and customizing the geometrical configuration of the grip to conform to the preference of a user.

### CROSS-REFERENCE TO RELATED APPLICATION

This application claims priority under 35 U.S.C. §119(e) to U.S. Provisional Patent Application No. 61/342,632, filed on Apr. 19, 2010, by James Claire, the entire disclosure of which is hereby incorporated herein by reference.

### FIELD OF THE INVENTION

The present invention generally concerns handles and more particularly relates to grips for handles.

### SUMMARY OF THE INVENTION

According to one aspect of the present invention, a method of making a grip for a handle is provided. The method includes forming a substantially cylindrical body portion from a material at least partially comprised of cork and forming an elongate cavity through the substantially cylindrical body portion. The method also includes separating the substantially cylindrical body portion into a plurality of ring segments each having an inner surface area, first side surface area, second side surface area, and an outer surface area, applying an adhesive to the inner surface area, first side surface area, and second side surface area and applying the ring segments to a handle, such that each of the plurality of ring segments securely adheres to the handle and to an adjacent ring segment. The method further includes pressing each of the plurality of ring segments onto the handle to form the grip and customizing the geometrical configuration of the grip to conform to the preference of a user.

According to another aspect of the present invention, a method of manufacturing a grip for a golf club is provided. The method includes providing a golf club including a shaft, providing a plurality of grip segments formed at least partially from a cork material, and forming a cavity in each of the grip segments, the cavity having a diameter that is slightly larger than a diameter of the shaft. The method further includes applying an adhesive to each of the grip segments, placing the grip segments over the shaft, adhering each of the plurality of grip segments to the shaft and to each adjacent grip segment, pressing each of the plurality of grip segments onto the shaft to form the grip, customizing an outer surface of the grip to suit the preferences of a user, and applying a top cap to the shaft proximate the grip, and applying a sealant to the outer surface of the grip.

According to yet another aspect of the present invention, a golf club is provided that includes a shaft having a first end and a second end, a clubhead located proximate the first end of the shaft, and a grip located proximate the second end of the shaft. The grip includes a plurality of cork segments longitudinally stacked into abutting engagement along an outer diameter of the shaft, wherein at least one of the cork segments includes a rubber material.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a perspective view of a golf club having a grip of a handle of the present invention;

FIG. 2 is a front elevational view of the grip of the handle of the present invention;

FIG. 3 is a front elevational exploded view of the grip of the handle of the present invention, illustrating a plurality of ring segments;

FIG. 4A is a top plan view of a circular ring segment of the grip of the handle;

FIG. 4B is a top plan view of a quadrilateral ring segment of the grip of the handle; and

FIG. 4C is a top plan view of a triangular ring segment of the grip of the handle.

### DESCRIPTION OF EMBODIMENTS

Reference will now be made in detail to present embodiments of the invention, examples of which are illustrated in the accompanying drawings. Wherever possible, the same reference numerals will be used throughout the drawings to refer to the same or like parts.

For purposes of description herein, the terms “upper,” “lower,” “right,” “left,” “rear,” “front,” “vertical,” “horizontal,” “top,” “bottom,” and derivatives thereof shall relate to the invention as shown in the drawings. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

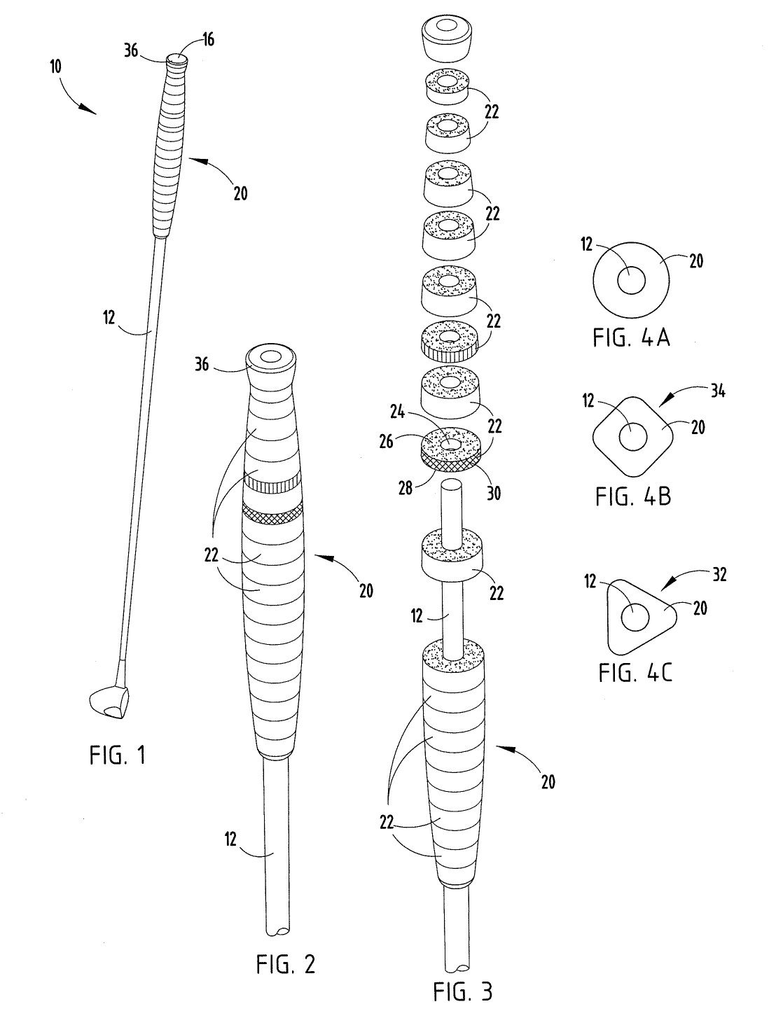

The reference numeral 10 (FIGS. 1-3) generally designates a golf club 10 that includes a shaft 12 having a first end 14 and a second end 16, a clubhead 18 located proximate the first end 14 of the shaft 12, and a grip 20 located proximate the second end 16 of the shaft 12. The grip 20 includes a plurality of cork segments 22 longitudinally stacked into abutting engagement along an outer diameter of the shaft 12, wherein at least one of the corked segments 22 includes a rubber material. It should be noted that although a golf club 10 is described herein, it is conceivable that the grip 20 for a handle may be employed for several other applications, including, but not limited to, a handle for a bow and arrow.

The plurality of cork segments 22 may comprise more than one type of cork and is not limited to a rubber cork material. The cork segments 22 may assume various geometric shapes, with each having a height of typically 1/32″ to 1.75″.

A method of manufacturing the grip 20 for the handle or shaft 12 is also provided. Using the example of a golf club 10, a golf shaft 12 is taken and measured for grip size and length. A raw piece of cork material is manufactured into a substantially cylindrical body portion and is then hollowed out in such a way to form an elongate cavity through the substantially cylindrical body portion. The cylindrical body portion is then separated, such as by cutting, into a plurality of ring segments 22, each having an inner surface area 24, a first side surface area 26, a second side surface area 28, and an outer surface area 30. The individual ring segments 22 are then glued to the shaft 12 and to each other at the same time period. This is accomplished by applying adhesive to the inner surface area 24 of each ring segment 22, the first side surface area 26 of each ring segment 22, and the second side surface area 28 of each ring segment 22, then placing the shaft 12 and the individual ring segments 22 into contact with each other.

In order to finally secure the individual ring segments 22 to the shaft 12, each cork ring segment 22 is pressed with a cork press at approximately 10-50 pounds of pressure. A settling and drying time of typically approximately 24 hours (depending on glue drying speed) is then provided. After this period, the shaft 12 may then be placed on a mechanical device, such as a lathe and/or belt sander, then shaped to a user's preference and specifications. Such preferences may include the outer diameter of the grip, grooves or indentations to accommodate for fingers and/or thumbs, manipulation into various geometric shapes (FIGS. 4A-4C), such as triangular 32 or rectangular 34, and aesthetic customization. The aesthetic preferences may be applied to any number of the individual ring segments 22, including the entire grip 20, and may include things such as snake hide, colored thread wraps, or leather. These are merely a few of the preferences that the user may decide to employ. Subsequent to the final customization of the grip 20, a top cap 36 is applied to the grip 20.

The process of shaping the grip 20 is done with the aforementioned tools, as well as sand paper and other shaping tools. After the club grip 20 is fit to the hand-size and mocked to the user's specifications, the cork is sealed with cork seal or banana oil in order to keep the colors bright and maintain the integrity of the cork.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method of making a grip for a handle comprising:
forming a substantially cylindrical body portion from a material at least partially comprised of cork;
forming an elongate cavity through the substantially cylindrical body portion;
separating the substantially cylindrical body portion into a plurality of ring segments each having an inner surface area, first side surface area, second side surface area, and an outer surface area;
applying an adhesive to the inner surface area, first side surface area, and second side surface area;
applying the ring segments to a handle, such that each of the plurality of ring segments securely adheres to the handle and to an adjacent ring segment;
pressing each of the plurality of ring segments onto the handle to form the grip; and
customizing the geometrical configuration of the grip to conform to the preference of a user.

2. The method of making a grip for a handle of claim 1, wherein a plurality of cork types are used to provide the plurality of ring segments.

3. The method of making a grip for a handle of claim 2, wherein at least one of the plurality of cork types is a rubber cork material.

4. The method of making a grip for a handle of claim 1, wherein the step of separating the substantially cylindrical body portion into a plurality of ring segments includes separating each ring segment to a height of at least approximately 1/32″ and less than approximately 1.75″.

5. The method of making a grip for a handle of claim 1, wherein the step of pressing each of the plurality of ring segments includes employing a force of approximately 10-50 lbs.

6. The method of making a grip for a handle of claim 1, further comprising the step of adding aesthetic features to the outer surface of the plurality of ring segments.

7. The method of making a grip for a handle of claim 5, further comprising the step of applying a sealant to the plurality of ring segments, wherein the sealant maintains the aesthetic appearance of the aesthetic features added to the plurality of ring segments.

8. A method of manufacturing a grip for a golf club comprising:
providing a golf club including a shaft;
providing a plurality of grip segments formed at least partially from a cork material;
forming a cavity in each of the grip segments, the cavity having a diameter that is slightly larger than a diameter of the shaft;
applying an adhesive to each of the grip segments;
placing the grip segments over the shaft;
adhering each of the plurality of grip segments to the shaft and to each adjacent grip segment;
pressing each of the plurality of grip segments onto the shaft to form the grip;
customizing an outer surface of the grip to suit the preferences of a user;
applying a top cap to the shaft proximate the grip; and
applying a sealant to the outer surface of the grip.

9. The method of manufacturing a grip for a golf club of claim 8, wherein a plurality of cork materials are used to provide the plurality of grip segments.

10. The method of manufacturing a grip for a golf club of claim 9, wherein the cork material is a rubber cork.

11. The method of manufacturing a grip for a golf club of claim 8, wherein the plurality of grip segments have a height of at least approximately 1/32″ and less than approximately 1.75″.

12. The method of manufacturing a grip for a golf club of claim 8, wherein the step of customizing the outer surface of the grip includes adding aesthetic features.

13. The method of manufacturing a grip for a golf club of claim 8, wherein the step of pressing each of the plurality of grip segments includes employing a force of approximately 10-50 lbs.

14. The method of manufacturing a grip for a golf club of claim 8, wherein the step of applying a sealant includes sealing with a sealant selectively chosen from the group consisting of banana oil and cork seal.

15. A golf club comprising:
a shaft having a first end and a second end;
a clubhead located proximate the first end of the shaft; and
a grip located proximate the second end of the shaft, wherein the grip comprises:
a plurality of cork segments longitudinally stacked into abutting engagement along an outer diameter of the shaft, wherein at least one of the cork segments includes a rubber material.

16. The golf club of claim 15, wherein the plurality of cork segments includes a rubber cork segment every other segment.

17. The golf club of claim 15, wherein the plurality of cork segments includes a rubber cork segment every third segment.

18. The golf club of claim 15, wherein the grip includes an outer overall surface having at least one customized surface shape and/or contour.

19. The golf club of claim 18, wherein said shape and/or contour comprises an overall grip characteristic of round, square, triangular, and grooved for thumb or finger canals.

20. The golf club of claim 15, wherein each of the plurality of cork segments is of a height of at least approximately 1/32″ and less than approximately 1.75″.
